(19) United States
(12) Patent Application Publication
(10) Pub. No.: US 2003/0158972 A1
(43) Pub. Date: Aug. 21, 2003

(54) Device and method for the synchronization of a system of networked computers

(76) Inventors: Markus Friedli, Zurich (CH); Rene Baumann, Embrach (CH)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/307,453

(22) Filed: Dec. 2, 2002

Related U.S. Application Data
(63) Continuation of application No. PCT/EP01/06240, filed on Jun. 1, 2001.

(30) Foreign Application Priority Data
Jun. 7, 2000 (EP) 00 112 203.5

(51) Int. Cl. G06F 15/16; H04L 1/22

(52) U.S. Cl. 709/248; 714/4

(57) ABSTRACT

The present invention relates to a system and method for synchronizing coupled multi-computer systems. The system and method increase availability and reliability. Multi-computer systems that use the inventive system only require one hardware timing clock or module, thus eliminating the risks caused by a synchronization of hardware timing modules. In order for a coupled computer to have a clock pulse, the latter is engaged by the time synchronization method. As each computer is usually equipped with a hardware timing module, the allocation of the active hardware timing module to a computer can be altered if necessary. Subsystem steps have been introduced into the inventive system to maintain an appropriate separation of the synchronization process from the applications. Said subsystem steps are independent of the operating system and the hardware. This permits the division of applications into constant elements without the system having to take into consideration the task of the application. Synchronization points for a validity check are defined between the steps.

### CROSS REFERENCE TO RELATED APPLICATIONS

This application is a continuation of International Application number PCT/EP01/06240, filed Jun. 1, 2001; and claims priority to European Patent Application 001 12203.5, filed Jun. 7, 2000; both of which are incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates to the field of computer networks and more particularly to a system and method for synchronizing networked computers.

Certain technical field, such as the railway industry, have strict safety regulations with respect to their computer networks. Failure of a computer or network most usually results in loss of revenue, resources, or possibly human life. As such, the safety regulations are met with computer systems incorporating redundancies for at least back up purposes.

Multi-computer systems may be built on so-called diversity hardware. A multiple computer system is based on diversified hardware if single components, such as processors, have a different architecture and are mostly produced by various producers. Errors are recognizable with diversified hardware which are inherent to a determined computer and in particular processor. To especially facilitate maintenance and logistics, the so-called unitary hardware is increasingly used, the hardware marked by a homogenous hardware structure. P Typical multi computer systems are known under the terms 2v2 and 2v3 and other configurations. In a 2v2 system, two computers are networked or coupled to each other by an interface. During a periodically performed comparison of status data of both computers, a further processing of the process data occurs if both computers each have determined equality during this comparison, alternatively, a failure corrective action occurs at a present inequality. All or at least safety relevant orders are not carried out at inequality and the system to be controlled is brought into a safe status.

In a 2v3 system, three computers are each connected by an interface with each other. A further processing of process data occurs only then at paired carried out comparison of status data, if two computers each have determined equality at a comparison. It is assumed thereby, that the third computer is in a full of errors status. Such methods are known under the term “voting”.

To fulfill the requested safety standards, a solution for unitary hardware is known, wherein each of the corresponding processors are supplied with a system cycle and both processors process the identical software. A comparison of data status and data flow is carried out on bus level and is recognized on one error at inequality. This solution is disadvantageous because a special comparator circuit is necessary which considers the running time differences.

A further solution exists therein, to compare those memory contents to determined times, from which the consistency of the safety relevant data is and/or should be relevant.

The previously mentioned solutions with the exception of the comparison on bus level, have in common that these mechanisms were always visible in form of especially provided codes within the applications at the development of safety relevant applications. In particular, each person entrusted with the development of such an application, has to deal not only with the application but also with the synchronizing of computers and/or of pending incoming and outgoing data.

An additional common disadvantage of the mentioned solutions is the use of individual clock generators on the computers, which have to be synchronized, expensively, from the time of starting the system, which again includes risks during the start-up.

### BRIEF SUMMARY OF THE INVENTION

An advantage of the present invention is to overcome the above mentioned problems and arrive at a system and method for synchronizing networked computers. A further advantage is to realize applications concerning safety regulations wherein a clear and simple separation of the classical application and synchronization is possible. These and other advantages are realized by a device for synchronizing a system including a plurality of networked computers, comprising: only one of said plurality of networked computers has one active hardware master clock assigned to it such that an operation of said clock may be defined by generated data, and wherein a synchronizing tick may be produced for a remainder of said plurality of networked computers by tick sending messages. The present invention further comprises a method for synchronizing a system including a plurality of networked computers which can execute time-dependant processes, comprising the steps of: a) producing a synchronizing tick by a hardware master clock of one of said plurality of computers, b) transmitting said synchronizing tick from said one of said plurality of computers by tick sending messages to a remaining of said plurality of networked computers, and c) executing processes by said plurality of networked computers in accordance with said synchronizing tick.

According to the inventive system, in multi computer systems, for example 2v2- or 2v3 systems, only an active hardware master clock is necessary, therefore the risks stemming from a mutual synchronization of hardware master clocks is eliminated. A cycle is therefore copied by the method of time synchronizing so that one too is available to a networked computer. Because each computer is provided with a hardware master clock, it is determined at the system's start, which computer is equipped with the so-called master-clock. This assignment is changeable during operation, if desired.

The device according to the invention and the method according to the invention are generally applicable for all types of computers.

To receive a fitting separation of the synchronization and applications, so-called subsystem steps for application processes have been introduced in the inventive method. These subsystem steps are independent from the operating system and hardware. This allows a splitting of the application processes into constant process elements without having to consider the task of the application processes. The subsystem steps of an application process are input, processing, and output. Between these steps lie the synchronizing points for an invalid character check.

The results of these subsystem steps are compared to the redundancy computers. This allows, in case of an error, fast access into the system which is particularly important at safety critical applications. A further advantage at correcting errors is the correcting possibility because a subsystem step can be corrected easier than a whole process.

The method according to the invention provides a standardized data interface for the mutual data exchange of the computers. The data to be controlled can be assigned simply and safely to the right processing steps by the standardization of the interface in connection with the definition of the synchronizing points. From this results the advantage that computers with multi-task systems can also use the method according to the invention without adding further systems and limitations. Data control can be parameterized by the flexible structure of the messages in the method according to the invention, which means, the message length can be adjusted to demands so that no data or on the other hand a great amount of data in an extreme case is delivered. This adds to the optimization of the synchronizing time. Additionally, the data itself can be also parameterized to execute a voting or for an improved comparison of the analogous values.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts a system architecture,

FIG. 2 depicts time synchronizing of a 2v2 system,

FIG. 3 depicts data synchronizing of a 2v2 system,

FIG. 4 depicts general data synchronizing structure, and

FIG. 5 depicts a message structure.

### DETAILED DESCRIPTION OF THE INVENTION

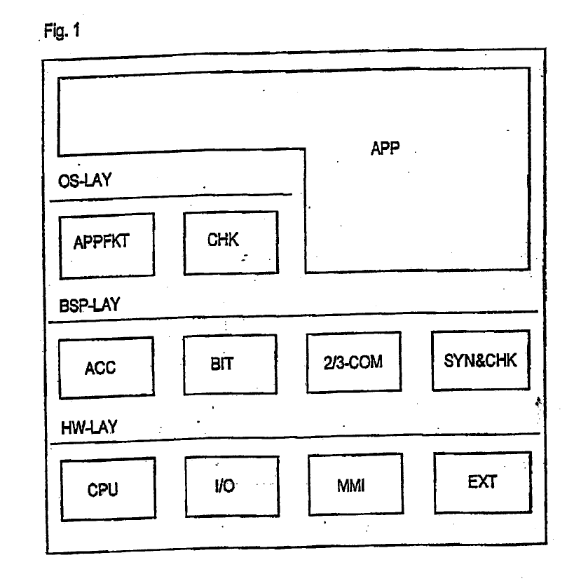

FIG. 1 depicts a typical structure of system architecture with four layers, hardware HW-LAY, driver BSP-LAY, operating system OS-LAY and application APP. This structure allows for a separation in layers of the methods of the hardware. It is evident, that applications APP operate directly with time critical functions, without detours to the operating system OS-LAY. In the system according to the invention, the units multi computer communication unit 2/3-COM and synchronizing and safety unit or process SYN&CHK are classified into the layer driver. This means, that the application APP is already separated from the synchronizing and safety unit SYN&CHK by the architecture. The synchronizing and safety unit SYN&CHK and the communicating unit 2/3-COM are preferably developed as autonomous driver functions, so that these units can work independently and are applicable to all applications APP, as well as to the operating system OS-LAY. The driver units work together with the hardware and are accordingly adjusted to the computer. Driver functions can also use other driver functions so that not all driver functions have to be adjusted to the hardware and universally valid standards can be found for many drivers.

Synchronization happens in two steps. On the one hand operating systems OS-LAY are synchronized; on the other hand data (application data) is synchronized.

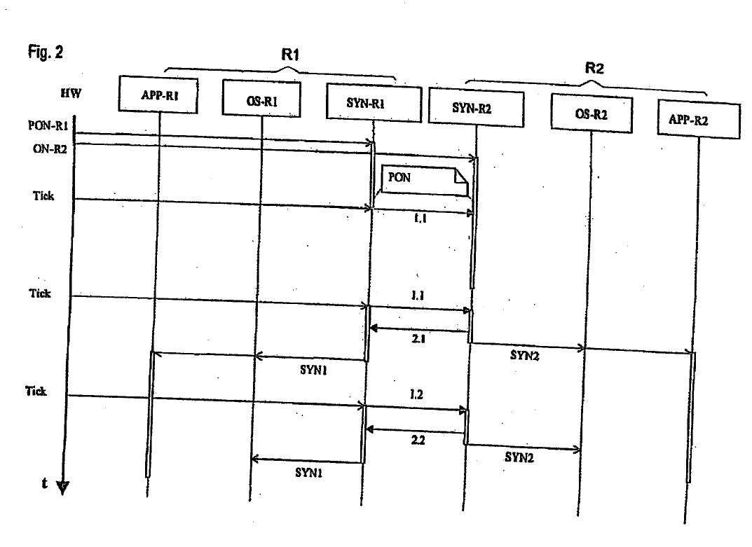

FIG. 2 depicts the structure of a time synchronization of the system according to the invention. With this time synchronizing it is realized that time, for the computer, becomes an external dimension. The time units start and end on all computers nearly at the same time. A synchronization among the computers can happen by serial connections.

The sequence diagram (FIG. 2) depicts the functioning of time synchronization for a 2v2 system. The method functions also for higher level systems.

One of the computers, denoted in FIG. 2 with R1, is determined as a kind of master; an active hardware master clock is available to and for it. But the method is not a master slave method. The computer R1 only serves as the definition of the sequence among the computers, to simplify the method and to clarify the boundary conditions. The error detection at boundary conditions is more difficult at absolutely equivalent computers. The master computer can particularly change at 2v3 systems, for example, if the original master was turned off.

The time synchronizing is started by an active hardware master clock HW on the computer R1. A clock-generated horary impulse of this hardware master clock or timing module is referred to as a clock pulse or tick. Both computers normally produce a message 1.1. and 2.1. for each tick of the master clock HW. After each occurrence of the tick, the synchronizing SYN-R1 of the computer R1 sends a message. The synchronizing SYN-R2 is started on the computer R2 by the arrival of this message from computer R1. If a correct message 1.1. was received, an own message 2.1. is sent back. At the same time the time synchronizing SYN2 for the own operating system OS-R2 is triggered. Based on the time synchronizing SYN2, actions can be triggered, for example the starting of an application APP-R2 or the data synchronizing or other in-/outputs.

The computer R1 releases its time synchronizing SYN1 of its operating system OSR1, after it has received a correct message 2.2. from computer R2. In this example the computer R1 started its application APP-R1.

During the initialization PON, for example after turning on the computer R1 and R2, the computer R1 sends the first message 1.1. as long as it receives a message 2.1. from computer R2.

The same procedure is used also at transmission interferences. If a message of computer R1 cannot be received correctly on computer R2, the computer R2 does not send back a message and the computer RI repeats the same message during the next tick. The number of repeats until abort. At transmission interferences from computer R2 to computer R1, the above can be implemented in much the same way.

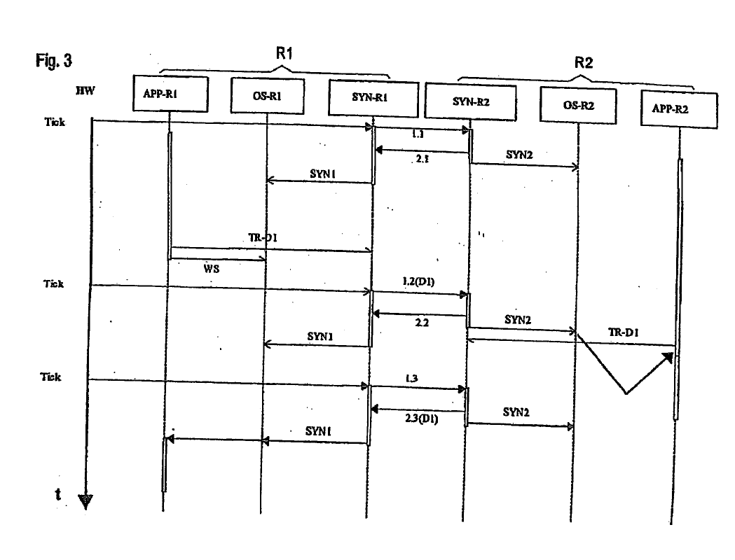

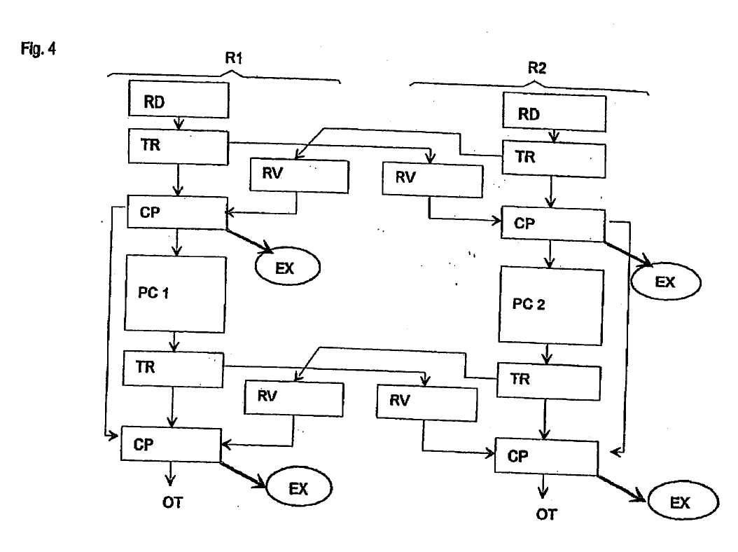

Messages in FIGS. 3 and 4 are labeled with time synchronizing data, computer number of the sender, and message number.

Two examples:

1.1: Computer R1, message 1

2.3: Computer R2, message 3

A precise assignment and checking are possible by such an address of the messages. The address can be extended, upon request.

To reliably detect an outage of the tick, a hardware master clock HW of each individual computer R1, R2 can be compared with the occurrence of the tick. By comparison, with the time grids to be defined, an outage of the tick can be definitely detected. The simultaneous outage of the hardware master clock on all computers can be controlled by a watch dog function.

FIG. 3 depicts a data synchronizing of asynchronous processes on the computers R1 and R2. The data synchronizing uses messages of a time synchronization for a data matching among the computers R1 and R2. If no data matching has taken place, only data about the time synchronization is available for the messages.

An application APP-R1 for example transmits data D1 to a driver module of a synchronization SYN-R1. This driver module now needs a tick by a hardware master clock HW to start the data synchronizing. The application APP-R1 now waits until it receives valid data D1 from computer R2 or starts an application specific exception procedure by a timeout checking. Such a status of waiting can be communicated to the operating system OS-RI with a message WS. In FIG. 3, the data D1 is transmitted to the driver module of the synchronization SYN-R2 of the computer R2 with the message 1.2 (D1). The computer R2 answers with the message 2.2 without data D1, because these are not ready yet from the application APP-R2. The data synchronizing of the computer R1 can therefore not yet synchronize the application APP-R1. The complete data D1 is placed at the disposal of the application APP-RI. As soon as the application APP-R1 has turned over its data D1 to the driver module SYN-R2, it now receives the data D1 from computer R1 for checking. The application APP-R2 can now continue its processing without delay. The data of the application APP-R2 is turned over with the next tick. The computer R1 now receives the data from computer R2 by an answer message 2.3 (D1), which is handed on to the application APPR1 from the driver module of the synchronization SYN-R1. Processing may continue after checking of the data D1.

It is possible, that the APP-R2 wants to turn over its data via the driver module SYNR2 to the computer R1, before the application APP-R1 is ready. For such an occurrence, the procedure routine stays the same.

It is furthermore possible that different partial processes of the application APP-R1 of the computer R1, which are called tasks and are worked off at the same time, want to turn over data within the same time upto or until the next tick. This different data is collected by the driver module of the synchronization SYN-R1 and turned over as described to the computer R2 as a message. The driver module SYN-R2 on the other side of the transmission divides the data into the different tasks of its computer, whereby the sequence of the data assignment of the sending computer is kept on the receiving computer for controlling and monitoring of the processes advantageously.

FIG. 4 elucidates the division of the applications into sub system steps to guarantee a continuous data synchronizing. Each application, partial application, process or task can be divided into the base units “reading of data” RD, “sending of data” TR, “receiving of data” RD, “checking of data” CP, and “processing of data” PC1 and PC2. Because of safety reasons, a checking of the data by synchronization with redundancy computers according to a “reading of data” RD and “a processing of data” PC1 and PC2 is recommended.

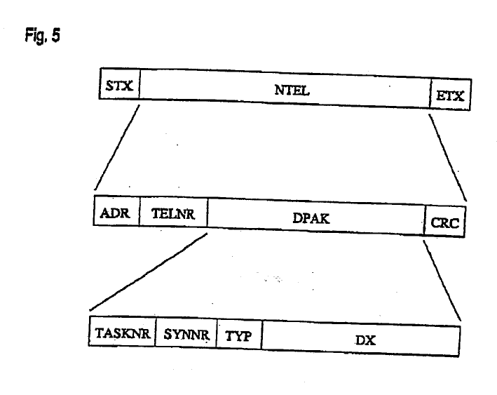

These places are called synchronizing points and can receive a synchronizing number SYNNR, according to FIG. 5, for identification. A system according to FIG. 4 supports unitary as well as diversified processing of data. If the checking of data CP detects an error, an error handling can immediately be started. The error handling EX is application specific and can for example cause a stopping of the computer with an external error message. If no errors are detected in such a sub system step, the data is passed on to the next sub system step OT for reading.

FIG. 5 shows an example message structure. A message starts with a starting identification key STX followed by the usable portion or message NTEL and an ending ETX. The starting identification key STX and the ending ETX are used for a safe recognition of the message. A useful message comprises the units:

address ADR for the identification of the computer,

message number TELNR as consecutive number for definite identification of the message,

variable amount of data DPAK of the data synchronization,

and a message checking CRC to confirm if a message has been genuinely transmitted. DPAK comprises:

a definite task number TASKNR of an application,

a number SYNNR of the synchronizing point within the corresponding task of the application,

information of the data type TYP, and

the actual data DX.

By specifying the data type, it is guaranteed that the data types on all participating computers are identical.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A device for synchronizing a system including a plurality of networked computers, comprising: only one of said plurality of networked computers has one active hardware master clock assigned to it such that an operation of said clock may be defined by generated data, and wherein a synchronizing tick may be produced for a remainder of said plurality of networked computers by tick sending messages.

2. The device according to claim 1, wherein said plurality of computers each comprises at least one synchronizing and safety unit, at least one communication module, a hardware layer, an operating layer, and a driver function, said computers are built in layers such that at least one synchronizing and safety unit and at least one communication module is arranged between said hardware layer and said operating layer and are developed as a driver function for said computers.

3. The device according to claim 1, wherein said plurality of computers each comprises at least one synchronizing and safety unit, at least one communication module, a hardware layer, an operating layer, and a driver function, said computers are built in layers such that at least one synchronizing and safety unit or at least one communication module is arranged between said a hardware layer and said operating layer and are developed as a driver function for said computers.

4. A method for synchronizing a system including a plurality of networked computers which can execute time-dependant processes, comprising the steps of:
a) producing a synchronizing tick by a hardware master clock of one of said plurality of computers,
b) transmitting said synchronizing tick from said one of said plurality of computers by tick sending messages to a remaining of said plurality of networked computers, and
c) executing processes by said plurality of networked computers in accordance with said synchronizing tick.

5. The method according to claim 4, further comprising the step of: in response to said transmitted synchronizing tick, transmitting by said remaining of said plurality of networked computers a reply message to said one of said plurality of computers, such that completeness and correctness of said reply message is controlled by said one of said plurality of computers.

6. The method according to claim 4, wherein said tick sending messages are completed with data for a data exchange among said plurality of computers, said data exchange being upon request.

7. The method according to claim 5, wherein said tick sending messages are completed with data for a data exchange among said plurality of computers, said data exchange being upon request.

8. The method according to claim 4, wherein sub system steps within a processes reading of data, processing of data and next subsystem step are defined wherein synchronizing points are reached for a data synchronization controlled by said synchronizing tick.

9. The method according to claim 5, wherein sub system steps within a processes reading of data, processing of data and next subsystem step are defined wherein synchronizing points are reached for a data synchronization controlled by said synchronizing tick.

10. The method according to claim 6, wherein sub system steps within a processes reading of data, processing of data and next subsystem step are defined wherein synchronizing points are reached for a data synchronization controlled by said synchronizing tick.

11. The method according to claim 4, wherein assignment of a hardware master clock to said one of said plurality of computers is statically realized during a procedure start by data which may be generated from a memory.

12. The method according to claim 5, wherein assignment of a hardware master clock to said one of said plurality of computers is statically realized during a procedure start by data which may be generated from a memory.

13. The method according to claim 6, wherein assignment of a hardware master clock to said one of said plurality of computers is statically realized during a procedure start by data which may be generated from a memory.

14. The method according to claim 8, wherein assignment of a hardware master clock to said one of said plurality of computers is statically realized during a procedure start by data which may be generated from a memory.

15. The method according to claim 11, wherein said assignment is changed during an operation depending upon the condition of said system.

16. The method according to claim 12, wherein said assignment is changed during an operation depending upon the condition of said system.

17. The method according to claim 13, wherein said assignment is changed during an operation depending upon the condition of said system.

18. The method according to claim 14, wherein said assignment is changed during an operation depending upon the condition of said system.
